(19) United States
(12) Patent Application Publication
(10) Pub. No.: US 2026/0110614 A1
(43) Pub. Date: Apr. 23, 2026

(54) Systems and Methods for Monitoring Cleanliness of a Substrate Processing Chamber

(71) Applicant: Applied Materials, Inc., Santa Clara, CA (US)

(72) Inventor: Raymond HUNG, Palo Alto, CA (US)

(21) Appl. No.: 18/924,796

(22) Filed: Oct. 23, 2024

(51) Int. Cl. G01N 15/075; G06T 7/00; H04N 23/74

(52) U.S. Cl. CPC G01N 15/075; G06T 7/0004; H04N 23/74; G06T 2207/10016; G06T 2207/20081

(57) ABSTRACT

Methods and apparatus for monitoring cleanliness of a substrate processing chamber are provided herein. In some embodiments, the method includes illuminating a surface of a component of the substrate processing chamber, the component surrounded by a chamber enclosure that is sealed from external light, the surface being illuminated by UV light generated from within a volume between the component and the enclosure; capturing an image of the illuminated surface; analyzing the captured image; determining based on the analyzing whether chamber cleaning is needed; and when it is determined that chamber cleaning is needed, generating an alert indicating that chamber cleaning is needed.

### FIELD

Embodiments of the present disclosure generally relate to substrate processing, and more particularly, to monitoring of cleanliness of substrate processing chambers.

### BACKGROUND

As a result of some semiconductor manufacturing processes, substrate processing equipment may come into contact with unwanted debris. Many substrate processes must be performed in an environment of specified cleanliness to provide a desired quality of output from the processes. Preventive maintenance (PM) on substrate processing equipment is often performed to clean the debris to achieve the specified level of cleanliness. However, preventive maintenance reduces uptime and output of the substrate processing equipment.

Often, preventive maintenance is performed periodically on a schedule, such as may be based on time or production throughput. However, the inventors have observed that fixed periods may be performed too frequently or infrequently. If preventive maintenance is performed too frequently, excessive downtime will result. Also, if preventive maintenance is performed too infrequently, reduced cleanliness may cause reduction in production yield due to processing in an environment that deviates from the specified cleanliness for the respective process.

Therefore, the inventors provide methods and systems of monitoring substrate processing chamber cleanliness to reduce downtime caused by preventive maintenance and improve production yield.

### SUMMARY

Methods and apparatus for monitoring cleanliness of a substrate processing chamber are provided herein. In some embodiments, the method of monitoring cleanliness of a substrate processing chamber includes: illuminating a surface of a component of the substrate processing chamber, the component surrounded by a chamber enclosure that is sealed from external light, the surface being illuminated by UV light generated from within a volume between the component and the enclosure; capturing an image of the illuminated surface; analyzing the captured image; determining based on the analyzing whether chamber cleaning is needed; and when it is determined that chamber cleaning is needed, generating an alert indicating that chamber cleaning is needed.

In some embodiments, a system is configured to monitor cleanliness of a substrate processing chamber. The system includes: a UV light source; a camera; and a controller coupled to at least one of the UV light source or the camera, the controller comprising: one or more processors; and one or more non-transitory computer readable media having instructions stored thereon which, when executed by the one or more processors, cause the one or more processors to perform: illuminating a surface of a component of the substrate processing chamber, the component surrounded by a chamber enclosure that is sealed from external light, the surface being illuminated by UV light generated from within a volume between the component and the enclosure; capturing an image of the illuminated surface; analyzing the captured image; determining based on the analyzing whether chamber cleaning is needed; when it is determined that chamber cleaning is needed, generating an alert indicating that chamber cleaning is needed; and when it is determined that chamber cleaning is not needed, repeating the illuminating, capturing, analyzing, and determining until it is determined that chamber cleaning is needed.

In some embodiments, a substrate processing chamber includes: an enclosure surrounding a volume, the enclosure being sealed from external light; a component disposed in the volume; a UV light source disposed in the volume and configured to illuminate a surface of the component; a camera disposed in the volume and configured to capture an image of the component when illuminated by the UV light source; and a controller in communication with the UV light source and the camera, the controller configured to analyze the image captured by the camera and determine, based on the analysis, whether chamber cleaning is needed, and generate an alert indicating that chamber cleaning is needed when it is determined that chamber cleaning is needed.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is a flow chart of a method in accordance with some embodiments of the present disclosure.

FIG. 2 is a schematic of a substrate processing chamber and a system in accordance with some embodiments of the present disclosure.

FIG. 3A is a schematic of a substrate processing chamber in accordance with some embodiments of the present disclosure.

FIG. 3B shows an example of particle distribution on a substrate.

FIG. 3C shows an example of images of particles from the example of FIG. 3B.

FIG. 4A is a schematic of a substrate processing chamber in accordance with some embodiments of the present disclosure.

FIG. 4B shows an example of particle distribution on a substrate.

FIG. 4C shows an example of images of particles from the example of FIG. 4B.

FIG. 5A is a schematic of a substrate processing chamber in accordance with some embodiments of the present disclosure.

FIG. 5B shows an example of particle distribution on a substrate.

FIG. 5C shows an example of images of particles from the example of FIG. 5B.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Embodiments of methods and apparatus for monitoring cleanliness of a substrate processing chamber are provided herein. The methods and apparatus described herein can use images and/or video of components of a substrate processing chamber to determine when the substrate processing chamber needs to be cleaned. When it is determined that chamber cleaning is needed, an alert can be generated indicating for users of the substrate processing chamber that chamber cleaning is needed. Thus, chamber cleaning can be performed when needed, rather than on a fixed schedule, which may be too frequent or too infrequent.

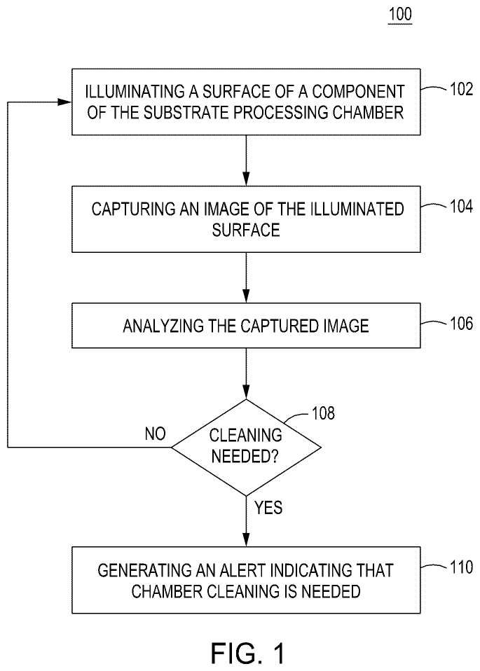

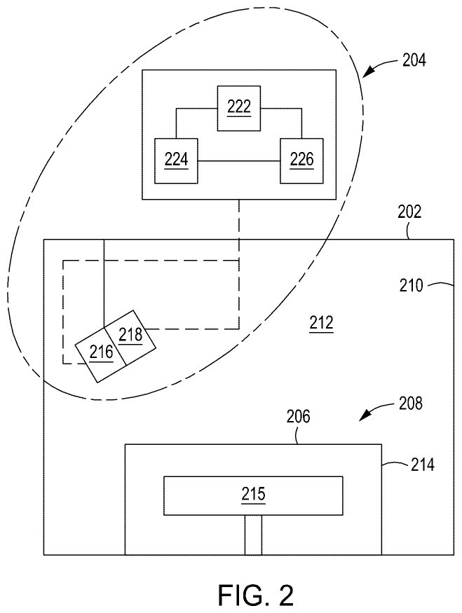

FIG. 1 is a flow chart of a method 100 in accordance with some embodiments of the present disclosure. The method 100 will be described herein with reference to a substrate processing chamber, such as the substrate processing chamber 202 shown in FIG. 2. At block 102, the method 100 may include illuminating a surface 206 of a component 208 of the substrate processing chamber 202.

In some embodiments, and as shown in FIG. 2, the substrate processing chamber 202 may include an enclosure 210 surrounding a volume 212, where the enclosure 210 is sealed from external light. The substrate processing chamber 202 also includes the component 208 disposed in the volume 212. In some embodiments, and as shown in FIG. 2, the component 208 may include a portion (e.g., a housing 214) that houses a substrate support 215 for supporting a substrate (not shown) during substrate processing (e.g., a wet clean process).

The substrate processing chamber 202 may also include a UV light source 216 disposed in the volume 212 and configured to illuminate the surface 206 of the component 208 a camera 218 disposed in the volume 212 and configured to capture an image of the component 208 when illuminated by the UV light source 216. A UV light source may be employed advantageously because some particles can be seen under UV light in a dark environment. Specifically, certain substances absorb UV light and then re-emit the absorbed energy almost immediately as visible light, which may be captured by the camera 218 as discussed in greater detail herein. In some embodiments, and a shown in FIG. 2, the camera 218 may be located proximate the UV light source 216. In some embodiments, and as shown in FIG. 2, the UV light source and the camera may be located at least partially in the volume 212 between the component and the enclosure.

In some embodiments, and as shown in FIG. 2, the substrate processing chamber 202 may include a controller 220 in communication with the UV light source 216 and the camera 218. The controller 220 may be configured to analyze the image captured by the camera 218 and determine, based on the analysis, whether chamber cleaning is needed, and generate an alert indicating that chamber cleaning is needed when it is determined that chamber cleaning is needed.

As shown in FIG. 2, the surface 206 may be illuminated by the UV light source 216 from within the volume 212. The surface 206 may be opaque or solid so that in some embodiments, UV light does not pass through the surface 206. The component 208 may be a component of a wet clean chamber configured for performing a wet clean process on a substrate.

At block 104, the method 100 may include capturing an image (e.g., with camera 218) of the illuminated surface 206. In some embodiments, capturing an image may include capturing a plurality of images or one or more video clips. In some embodiments, when the surface 206 is illuminated by UV light, particles that may be on the surface 206 become illuminated by the UV light and will glow as bright spots so that the camera 218 can capture the contrast between the bright spots and the surrounding area of the surface 206 to determine the presence of the particles.

In some embodiments, at least one of the UV light source 216 or the camera 218 may be remotely moveable (e.g., zoom, pan, tilt, dolly, truck, pedestal, rack focus) relative to the component 208 within the volume 212 to illuminate and/or capture different surfaces of the component 208. In some embodiments, the controller 220 may be configured to cause the remote movement of the UV light source 216 and/or the camera 218.

At block 106, the method 100 may include analyzing the captured image. The analyzing may include identifying, e.g., from the bright spots of the particles in the images, at least one of number, size, particle density, or location of particles on the component 208. The location of particles may be a numerical ranking based on importance of cleanliness of the location to substrate processing. In some embodiments, various locations of the component 208 may be associated with rankings. In some embodiments, the analysis of captured images may include monitoring or otherwise tracking changes in the images, such as the rate of change of at least one of number, size, particle density, or location of particles on the component 208 (i.e., spatial distribution). Monitoring may be conducted periodically (e.g., after processing one or more substrates) or as requested.

At block 108, the method 100 may include determining, based on the analyzing, whether chamber cleaning is needed. By reviewing the images or videos, a user or apparatus (e.g., controller 220) may judge whether the cleanliness of the substrate processing chamber 202 has deteriorated to a threshold level of cleanliness and determine if and when the chamber should be opened for a cleaning procedure or a full preventive maintenance. When it is determined that chamber cleaning is needed (YES at block 108), the method 100 may include generating an alert indicating that chamber cleaning is needed at block 110. When it is determined that chamber cleaning is not needed (NO at block 108), the method 100 may include repeating the illuminating, capturing, analyzing, and determining at blocks 102-108 until it is determined that chamber cleaning is needed at block 108.

In some embodiments, determining whether chamber cleaning is needed may include processing the captured image(s) or video with a software algorithm or smart system (e.g., machine learning model) to automatically analyze the captured image(s) or video, which may be used to generate an output (e.g., visual and/or audible indicator) to alert a user of the substrate processing chamber 202 about deteriorated chamber cleanliness conditions so that the user can take appropriate action to improve the chamber cleanliness conditions.

In some embodiments, one or more predefined thresholds indicative of deteriorated chamber cleanliness may be set for at least one of number, size, particle density, or location of particles on the component 208. Measurements of at least one of number, size, particle density, or location of particles on the component 208 obtained from analyzing the captured image may be compared to the one or more predefined thresholds to make one or more determinations about whether the predefined maximum thresholds have been exceeded. In some embodiments, if one (or some predefined combination) of the predefined thresholds has been exceeded, a determination may be made that chamber cleaning is needed.

In some embodiments, the rate of change of one or more parameters, such as number, size, particle density, or location of particles on the component 208, may be used for making determinations about chamber cleanliness. For example, one or more predefined thresholds may be set for the rate of change of at least one of number, size, particle density, or location of particles on the component 208. Measurements of the rate of change of at least one of number, size, particle density, or location of particles on the component 208 obtained from analyzing the captured image may be compared to the one or more predefined thresholds of the rate of change to make one or more determinations about whether the predefined maximum thresholds have been exceeded. In some embodiments, if one (or some predefined combination) of the predefined thresholds has been exceeded, a determination may be made that chamber cleaning is needed.

In some embodiments, and as shown in FIG. 2, a system 204 configured to monitor cleanliness of the substrate processing chamber 202 may include the UV light source 216, the camera 218, and the controller 220. In some embodiments, the controller 220 may include one or more processors 222 and memory 224 (one or more non-transitory computer readable media) having instructions stored thereon which, when executed by the one or more processors 222, cause the one or more processors 222 to perform a method, such as the method 100, of monitoring cleanliness of the substrate processing chamber 202. In some embodiments, the controller 220 is configured to identify at least one of number, size, or location of particles on the component 208.

In some embodiments, the processor 222 (programmable) is operable with the memory 224 and a mass storage device, an input control unit, and a display unit (not shown), such as power supplies, clocks, cache, input/output (I/O) circuits, and support circuits 226 coupled to the various components of the system 204 to facilitate control of the system 204. Support circuits 226 may be coupled to the processor 222 for supporting the processor 222 in a conventional manner.

To facilitate control of the system 204 described above, the processor 222 may be one of any form of general-purpose computer processor that can be used in an industrial setting, such as a programmable logic controller (PLC), for controlling various chambers and sub-processors. The memory 224 coupled to the processor 222 can be non-transitory computer readable storage medium and may be one or more of readily available memory such as random access memory (RAM), read only memory (ROM), floppy disk drive, hard disk, or any other form of digital storage, local or remote. Illumination, image acquisition, image analysis, and other processes are generally stored in the memory 224, typically as software routine. The software routine may also be stored and/or executed by a second processor (not shown) that is remotely located from the system being controlled by the processor 222.

The memory 224 may be in the form of computer-readable storage media that contains instructions, which when executed by the processor 222, facilitates the operation of the system 204. The instructions in the memory 224 may be in the form of a program product such as a program that implements the method in accordance with embodiments of the present disclosure. The program code may conform to any one of a number of different programming languages. In one example, the disclosure may be implemented as a program product stored on a computer-readable storage media for use with a computer system. The program(s) of the program product define functions of the embodiments (including the methods described herein). Illustrative non-transitory computer-readable storage media include, but are not limited to: (i) non-writable storage media (e.g., read-only memory devices within a computer such as CD-ROM disks readable by a CD-ROM drive, flash memory, ROM chips, or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such non-transitory computer-readable storage media, when carrying computer-readable instructions that direct the functions of the methods described herein, are embodiments of the present disclosure.

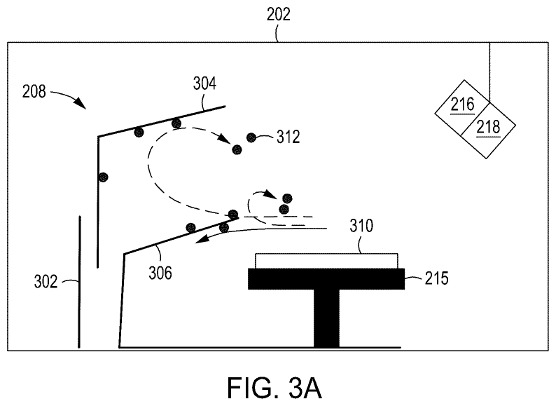

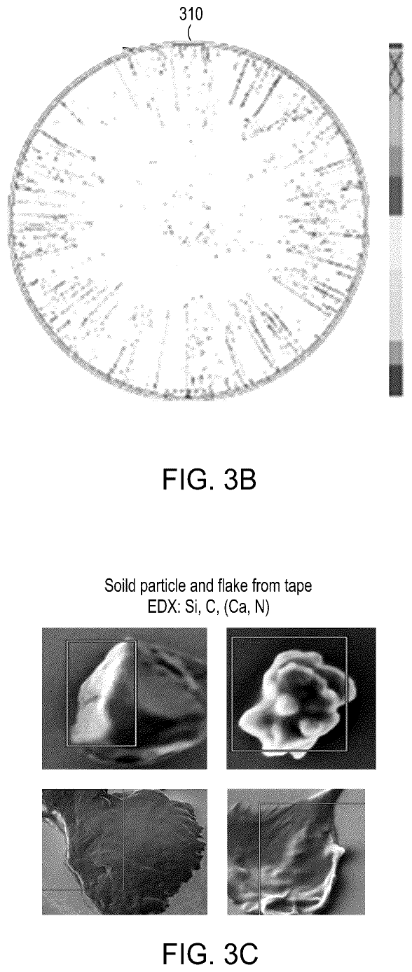

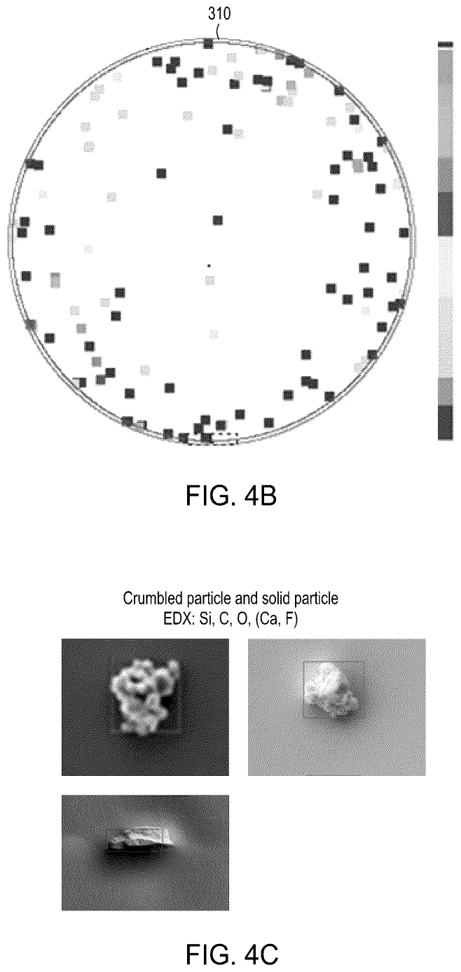

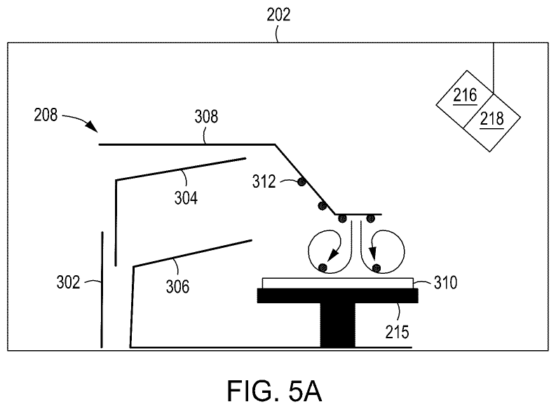

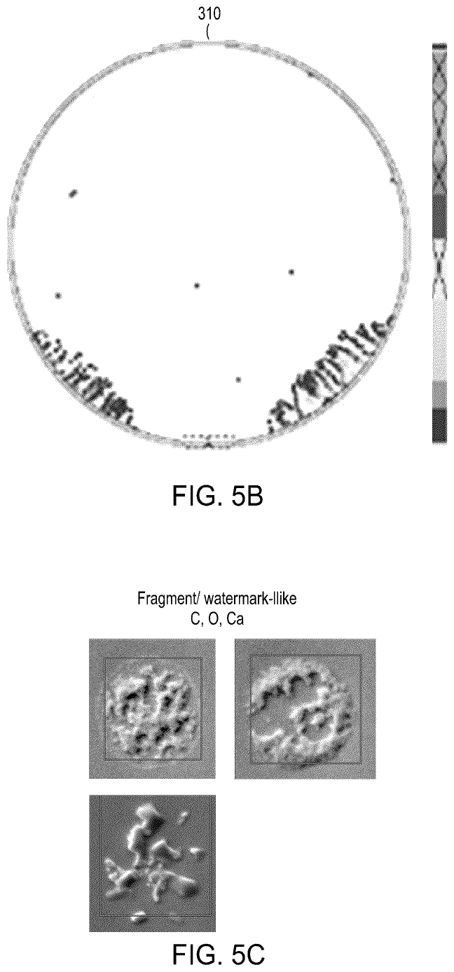

FIGS. 3A-5C show additional details of the substrate processing chamber 202 configured as a wet clean chamber for performing wet clean processing on a substrate 310. In some embodiments, and as shown in FIGS. 3A, 4A, and 5A, the component 208 may include a lower weir 302, an upper weir 304, and an inner weir 306. In some embodiments, and as shown in FIG. 5A, the component 208 may include an arm and nozzle assembly 308. In some embodiments, and as shown in FIGS. 3A, 4A, and 5A the upper weir 304 may be configured to move vertically between a raised position (FIGS. 3A and 5A) and a lowered position (FIG. 4A). In some embodiments, and as shown in FIG. 5A, the arm and nozzle assembly 308 may be configured to move (e.g., rotate, swing, or translate) into a position to dispense fluid (e.g., liquid) onto the substrate 310 during a wet clean process. As shown in FIGS. 3A, 4A, and 5A, the UV light source 216 and the camera 218 may be located and positioned relative to the component 208 and/or the substrate 310 so that various surfaces of the component 208 or any exposed surfaces of the substrate 310 may be illuminated by the UV light source 216 and captured by the camera 218. The camera 218 may be mounted in the substrate processing chamber 202 to have line of sight to one or more surfaces of the component 208 or the substrate 310.

As shown in FIG. 3A, particles 312 that are on inner surfaces of the upper weir 304 and/or the inner weir 306 may cross-contaminate a front side of the substrate edge through splashing back in a front side rinse and dry step of the wet clean process. The wetted particles 312 may be swung outward causing a streak signature or pattern on the substrate 310 as shown in FIG. 3B. Images of the particles 312, their shape, location, and pattern, may be captured by the camera 218 for analysis when the upper weir 304 is raised. For example, the streak signature or pattern may be identifiable during image analysis of the particles 312 as described herein. In some embodiments, a machine learning model used for image analysis may be trained using images of the particles 312, their shape, location, and pattern. FIG. 3C shows images of the particles 312 captured by the camera 218, showing the ability to distinguish between solid particles and flakes.

As shown in FIG. 4A, particles 312 on the substrate support 215 and/or clamping fingers (not shown) may be spread to a front side substrate edge during a backside rinse and dry step of the wet clean process. Images of the particles 312, their shape, location, and pattern, may be captured by the camera 218 for analysis. FIG. 4B shows particles 312 on the substrate 310 in a pattern along the front side substrate edge. FIG. 4C shows images of the particles 312 captured by the camera 218, showing the ability to distinguish between solid particles and crumbled particles.

As shown in FIG. 5A, particles 312 on the spray arm and nozzle assembly 308 may be spread to the substrate 310 as a result of splashing-dripping during the wet clean process. The methods and apparatus described herein may be applicable to particles deposited during other processes and processing chambers that facilitate the use of a camera and UV light source as described herein (i.e., where particles are on surfaces of a chamber component in a dark environment sealed from external light).

Images of the particles 312, their shape, location, and pattern, may be captured by the camera 218 for analysis. As shown in FIG. 5B, the particles 312 may settle down near the outer edge of the substrate 310 and aggregate into a watermark shape as water evaporates during a drying step of the wet clean process. FIG. 5C shows images of the particles captured by the camera 218, showing the ability to distinguish fragments and watermarks.

The methods and apparatus described herein allow users to view an interior portion of a substrate processing chamber that is otherwise blocked from the outside. More specifically, the methods and apparatus enable users to monitor and analyze the cleanliness conditions through one or more images or video clips that are captured by the apparatus. Without the ability to analyze the captured images, users may have to open the substrate processing chamber and halt substrate processing to examine the cleanliness conditions. Thus, the methods and apparatus described herein may reduce disruptions and increase substrate processing chamber utilization with less downtime. In addition, the methods and apparatus described herein may act as an alert system for users to take appropriate preventive action (e.g., chamber cleaning or preventive maintenance) before excessive particle buildup in the substrate processing chamber.

While the foregoing is directed to embodiments of the present disclosure, other and further embodiments of the disclosure may be devised without departing from the basic scope thereof.

1. A method of monitoring cleanliness of a substrate processing chamber, the method comprising:
illuminating a surface of a component of the substrate processing chamber, the component surrounded by a chamber enclosure that is sealed from external light, the surface being illuminated by UV light generated from within a volume between the component and the enclosure;
capturing an image of the illuminated surface;
analyzing the captured image;
determining based on the analyzing whether chamber cleaning is needed; and
when it is determined that chamber cleaning is needed, generating an alert indicating that chamber cleaning is needed.

2. The method of claim 1, the analyzing includes identifying at least one of number, size, particle density, or location of particles on the component.

3. The method of claim 2, wherein the determining includes comparing the at least one of number, size, particle density, or location of particles on the component to one or more predefined thresholds indicative of deteriorated chamber cleanliness, and determining, based on the comparison whether chamber cleaning is needed.

4. The method of claim 1, wherein the component includes a portion that houses a substrate support.

5. The method of claim 1, wherein the determining includes processing the captured image with a machine learning model.

6. The method of claim 1, wherein capturing an image includes capturing a plurality of images or video.

7. The method of claim 1, wherein the surface is opaque or solid.

8. A system configured to monitor cleanliness of a substrate processing chamber, the system comprising:
a UV light source;
a camera; and
a controller coupled to at least one of the UV light source or the camera, the controller comprising:
one or more processors; and
one or more non-transitory computer readable media having instructions stored thereon which, when executed by the one or more processors, cause the one or more processors to perform:
illuminating a surface of a component of the substrate processing chamber, the component surrounded by a chamber enclosure that is sealed from external light, the surface being illuminated by UV light generated from within a volume between the component and the enclosure;
capturing an image of the illuminated surface;
analyzing the captured image;
determining based on the analyzing whether chamber cleaning is needed; and
when it is determined that chamber cleaning is needed,
generating an alert indicating that chamber cleaning is needed.

9. The system of claim 8, wherein the analyzing includes identifying at least one of number, size, particle density, or location of particles on the component.

10. The system of claim 9, wherein the determining includes comparing the at least one of number, size, particle density, or location of particles on the component to one or more predefined thresholds indicative of deteriorated chamber cleanliness, and determining, based on the comparison whether chamber cleaning is needed.

11. The system of claim 8, wherein the determining includes processing the captured image with a machine learning model.

12. The system of claim 8, wherein capturing an image includes capturing a plurality of images or video.

13. The system of claim 8, wherein the surface is opaque or solid.

14. The system of claim 8, wherein the component is a component of a wet clean chamber.

15. A substrate processing chamber comprising:
an enclosure surrounding a volume, the enclosure being sealed from external light;
a component disposed in the volume;
a UV light source disposed in the volume and configured to illuminate a surface of the component;
a camera disposed in the volume and configured to capture an image of the component when illuminated by the UV light source; and
a controller in communication with the UV light source and the camera, the controller configured to analyze the image captured by the camera and determine, based on the analysis, whether chamber cleaning is needed, and generate an alert indicating that chamber cleaning is needed when it is determined that chamber cleaning is needed.

16. The substrate processing chamber of claim 15, wherein at least one of the UV light source or the camera is remotely moveable within the volume.

17. The substrate processing chamber of claim 15, wherein the component is a component of a wet clean chamber.

18. The substrate processing chamber of claim 15, wherein the surface of the component is opaque or solid.

19. The substrate processing chamber of claim 15, further comprising a substrate support housed at least partially by the component.

20. The substrate processing chamber of claim 15, wherein the controller is configured to identify at least one of number, size, or location of particles on the component.
